(19) United States
(12) Patent Application Publication
(10) Pub. No.: US 2012/0273271 A1
(43) Pub. Date: Nov. 1, 2012

(54) MEASUREMENT-WHILE-DRILLING MUD PULSER AND METHOD FOR CONTROLLING SAME

(76) Inventor: William Stuart-Bruges, Newbury (GB)

(21) Appl. No.: 13/451,571

(22) Filed: Apr. 20, 2012

(30) Foreign Application Priority Data
Apr. 28, 2011 (CA) 2738271

(51) Int. Cl. E21B 47/24; E21B 21/08; G01V 3/00

(52) U.S. Cl. 175/38; 340/853.3

(57) ABSTRACT

A measurement-while-drilling mud pulser and a method for controlling a measurement-while-drilling mud pulser. The mud pulser includes a brushless DC motor that hydraulically controls a main restrictor valve that the mud pulser uses to generate mud pulses. Back EMF signals generated in the stator windings of the brushless DC motor are monitored and are used as the basis for commutating the brushless DC motor. The phase transitions in the back EMF signals can be used in governing stator energizations of the brushless DC motor to thereby govern its rotation. Relying on back EMF signals for commutation allows commutation to be performed without Hall Effect or other kinds of sensors, which can thereby reduce cost of the mud pulser and further increase reliability of the mud pulser by decreasing the number of high pressure sealings needed due to wires from Hall effect sensors, which are prone to develop leaks.

### BACKGROUND OF THE INVENTION

1. Field of the Invention

Embodiments of the invention relate to a measurement-while-drilling mud pulser and a method for controlling same. More particularly, the present disclosure is directed at a measurement-while-drilling mud pulser that utilizes a sensorless, brushless DC motor to actuate a valve that generates mud pulses. Instead of relying on sensors to determine rotor (and thus valve) position for mud pulses, back EMF signals that the motor generates during operation are used to determine how and when to commutate the motor so as to generate the desired mud pulses.

2. Description of the Related Art

The importance of directional drilling in the oil industry continues to increase.

The drilling of directional oil wells requires that information related to bit orientation as well as data relating to the type of geological formation then being drilled be continuously transmitted to surface so that corrections can be made to the drill bit's orientation so as to guide the wellbore in the desired direction, and receive information as to the geologic formation being encountered.

When performing directional drilling, a measurement-while-drilling mud pulser is commonly used to transmit such variety of measurements obtained downhole to the surface for processing via mud pulses, referred to as mud pulse telemetry. The mud pulser operates by modulating, downhole, pressure of the drilling fluid or ‘mud’ which is being pumped down the hollow drill pipe, in order to thereby transmit to surface, through the modulated pressure variations in the drilling mud, information relating to bit orientation and geologic formation.

Many designs of mud-pulse apparatus have been used downhole, with varying success. One such mud-pulse apparatus design includes a main modulating valve which incorporates hydraulic feedback, responsive to control signals from a small solenoid-operated pilot valve.

Another known mud pulser design includes a pilot valve in a first end wall which when open provides a fluid communication path between the borehole and a first variable volume chamber. The valve seat has a number of valve ports which are revealed or blocked by a valve member.

The use of reversible electric motors to operate a pilot valve has been made.

Another known example of a mud pulser design has a DC motor where the motor drives in one direction only, and is used as a generator in the other directions, thus receiving hydraulic power, due to the large change in pressure between the opening and closing portions of its duty cycle.

Another known example discloses a mud pulser having a DC motor. A servo-valve comprising a servo-poppet (valve poppet) and servo-orifice is provided, wherein mud is permitted to flow through the servo-orifice when the servo-poppet is in an open position and restricted from flowing when the servo-poppet is in a closed position (when the poppet is lifted from the valve seat, mud flows “from the inlet ports of the spacer past the seat and into the valve guide and then out to the annulus of the well”). The servo-poppet is also powered both to the open and restricted positions in a reciprocating linear movement away from and towards, respectively, the servo-orifice through a rotary-to-linear converter means (ball screw) by a reversible rotary electric motor.

Another example of a DC motor-operated mud pulser includes an electric motor which is used together with Hall effect shaft sensors and counter for sensing pilot valve position in order to modulate the control valve and thus mud pulses being transmitted to surface.

Mud pulsers which incorporate shaft position sensors, with their associated extra wiring which must be fed through expensive and bulky pressure barriers to the control electronics, are necessarily complicated in design, and expensive due to not only the cost of the sensors but also the cost of the more complicated design and wiring.

As well, reliability and efficiency of operation of a mud pulser is an important consideration. Due to the mud pulser necessarily being located downhole close to the drilling bit when a well is being drilled, failure of such mud pulser, or expiration of battery life for such mud pulser, results in having to remove (bring to surface) the entire drill string to replace the mud pulser, which is in itself an expensive and time-consuming task, to say nothing of the expense incurred in “downtime” in not being able to use the well to produce oil.

Conventional brushless DC motors (“BLDC motors) used in mud pulsers of the prior art rely on sensors, such as Hall Effect sensors, mounted on the motor's stator to determine position of the rotor relative to the stator and how (and when) to effectively commutate the motor (ie govern the respective energization of the respective stator windings of the DC motor so as to govern rotation of the DC motor). However, using sensors to control BLDC motors in mud pulsers can be troublesome because the wiring for the sensors is threaded through expensive and bulky high pressure feedthroughs (ie high pressure sealings which are required to seal positions where the Hall effect sensor wires are used). Using high pressure feedthroughs is undesirable because they can reduce the mud pulser's reliability, and because there may be insufficient space inside the mud pulser to easily accommodate a substantial number of the feedthroughs.

While Hall Effect sensors can alternatively be avoided by using brushed DC motors, doing so introduces different reliability problems, since the high pressure, oil-filled environment in which the brushed DC motors operate can interfere with proper operation and reliability of the brushes.

### BRIEF DESCRIPTION OF THE INVENTION

According to an embodiment of the present invention, a method for controlling a measurement-while-drilling mud pulser is provided. The method comprises: operating a brushless DC motor that controls a main restrictor valve in the mud pulser used to generate mud pulses; measuring back EMF signals generated in the stator windings of the brushless DC motor during motor operation; and governing the rotation of the brushless DC motor based on the back EMF signals.

According to another embodiment of the present invention a measurement-while-drilling mud pulser is provided. The mud pulser comprises: a housing; a pilot valve contained within the housing and movable between completely opened and completely closed positions; a main restrictor valve hydraulically coupled to the pilot valve and movable between opened and closed positions in response to movement of the pilot valve; a motor assembly comprising a brushless DC motor, the brushless DC motor mechanically coupled to the pilot valve to move the pilot valve between the completely opened and completely closed positions; motor control circuitry electrically coupled to the motor assembly, wherein the motor control circuitry is configured to: operate the brushless DC motor; measure back EMF signals generated in the stator windings of the brushless DC motor during motor operation; and govern rotation of the brushless DC motor based on the back EMF signals.

According to another embodiment of the present invention, a measurement-while-drilling mud pulser is provided. The mud pulser comprises: a housing; a pilot valve contained within the housing and movable between completely opened and completely closed positions; a main restrictor valve hydraulically coupled to the pilot valve and movable between opened and closed positions in response to movement of the pilot valve; a motor assembly comprising a brushless DC motor, the brushless DC motor mechanically coupled to the pilot valve to move the pilot valve between the completely opened and completely closed positions; motor control circuitry electrically coupled to the motor assembly, the motor control circuitry further comprising: means for energizing stator windings of the brushless DC motor; means for measuring back EMF signals generated by the stator windings of the brushless DC motor during motor operation; and means for individually energizing, when desired, the individual stator windings, based on the back EMF signals.

### BRIEF DESCRIPTION OF THE DRAWINGS

Other objects, features and advantages of the embodiments of the present invention will appear on reading the following description, given only as a non-limiting example, and made with reference to the appended drawings in which:

FIG. 1 is a side sectional view of a mud pulser, according to a first embodiment;

FIGS. 2(a) and (b) show graphs of one or more of Hall Effect sensor output, back EMF, and phase current for exemplary brushless DC motors that can be used in the mud pulser of FIG. 1;

FIG. 3 is a block diagram depicting exemplary motor control circuitry that can be used to control the brushless DC motor used in the mud pulser of FIG. 1;

FIG. 4 is a schematic of a circuit representing hydraulic operation of the mud pulser of FIG. 1; and

FIG. 5 is a method for controlling a mud pulser that incorporates a sensorless, brushless DC motor, according to another embodiment.

### DETAILED DESCRIPTION OF THE INVENTION

Directional terms such as “top”, “bottom”, “upwards”, “downwards”, “vertically” and “horizontally” are used in the following description for the purpose of providing relative reference only, and are not intended to suggest any limitations on how any apparatus is to be positioned during use, or to be mounted in an assembly or relative to an environment.

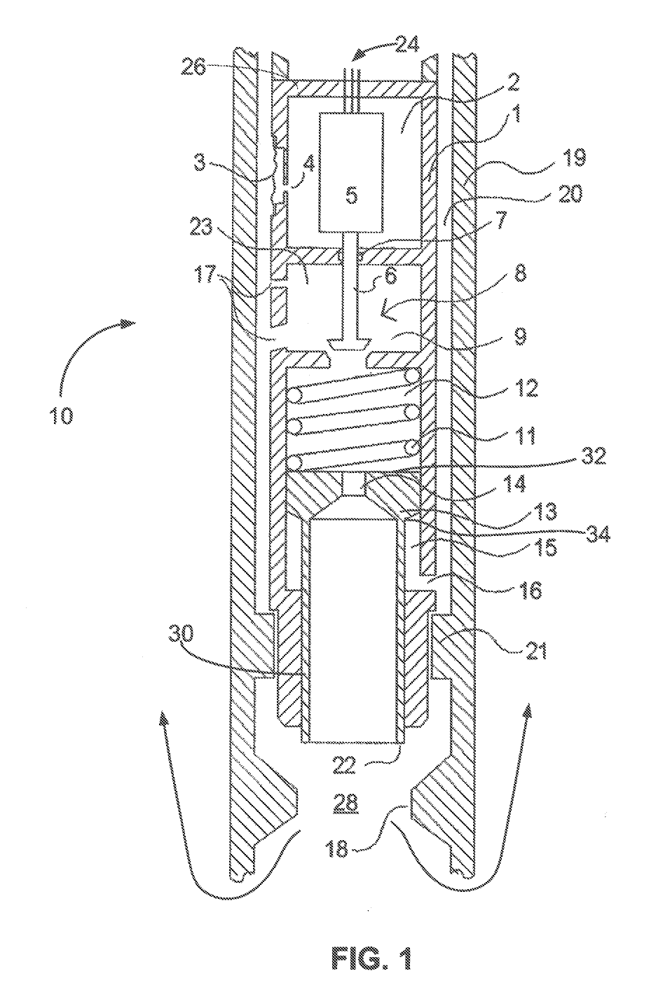

FIG. 1 shows a drill pipe bottom hole assembly (hereinafter referred to simply as the “drill pipe”) 19 in which an exemplary mud pulser 10 is deployed. The mud pulser 10 includes a main housing 1 retrievably located on fins 21 provided in the drill pipe 19. The connection with the drill pipe 19 may also include a mule shoe arrangement to ensure rotational alignment of directional sensors housed in the mud pulser 10. The main housing 1 is smaller in diameter than the drill pipe 19 so as to create an annulus 20 though which drilling mud can flow. An orifice collar 18 is provided in the drill pipe 19 below the fins 21 for creating an orifice or restriction 28 in the flow of drilling mud in the pipe. As indicated by the arrows in FIG. 1, drilling mud can therefore flow along the annulus 20, past the fins 21, and through the orifice 28 to exit the drill pipe 19 and return, following the arrows shown, via an annulus between the drill pipe 19 and the walls of the bore hole (not shown).

A main piston 13 is provided within a chamber in housing 12. The piston 13 divides the chamber into an upper chamber 12 and a lower chamber 15. The piston 13 is acted upon by a compression spring 11 located between an upper face 32 of the piston 13 and a top wall of the chamber 12 so that the piston 13 is biased to move downwards towards the orifice 28 in the drill pipe 19. A hollow cylinder 30 extends from a lower face 34 of the piston 13 and out of the chamber 15 towards the orifice 28, so that when the main housing 1 is located by the fins 21 in the drill pipe 19, the open end of the hollow cylinder 30 acts as a valve tip 22 that can be moved into the flow of mud through the orifice 28 to create a pressure increase in the mud in the annulus 20. As discussed in further detail below, the combination of the hollow cylinder 30 and the orifice 28 acts as a main restrictor valve responsible for generating the pressure pulses in the mud that are used to communicate with the surface.

The hollow cylinder 30 communicates with the upper chamber 12 via a control port 14 provided in the main piston 13. At the same time, a port 16 in the main housing 1 allows drilling mud to enter the lower chamber 15 underneath the lower face 34 of the piston 13.

A pilot valve chamber 23 is provided in the housing 1, and fluid communication with the upper chamber 12 is regulated by means of a pilot valve 8 in the top of an end wall of the upper chamber 12. In the depicted embodiment the pilot valve 8 is in the form of a linearly reciprocating “poppet and orifice” type valve, although a rotary valve could alternatively be used. The pilot valve 8 in the form shown includes a shaft 6, having a disc 35 at one end, that is movable such that the disc 35 blocks a valve seat/orifice 9 thus preventing mud flow through the pilot valve 8 from chamber 23 to chamber 12 or vice versa. The shaft 6 is linearly reciprocated by a motor assembly 5, discussed in more detail below. Mud from the drill pipe 19 enters the pilot valve chamber 23 via ports 17. When the pilot valve 8 is open, mud may flow from the pilot valve chamber 23 into the upper chamber 12 through the valve seat/orifice 9. By “open”, it is meant that there is a gap present between the disc 35 on the end of the shaft 6 and the valve seat/orifice 9 through which at least some of the mud may flow. The gap may partially, but not entirely, block the valve seat/orifice 9 such that the flow of the mud can be restricted, but not stopped. Accordingly, “open” includes both partially open, in which the flow of the mud is restricted but not stopped, and completely open, in which the mud flows unrestricted by the shaft 6 or the disc through the valve seat/orifice 9. “Closed” includes the state in which the disc 35 at the end of the shaft 6 is inserted into the valve seat/orifice 9 as far as possible, or such that the flow of the mud is stopped.

The ports 16, 17, as well as the valve seat/orifice 9, can be made too large to be blocked by lost-circulation material (“LCM”) and other particulates in the drilling mud, and may also be angled to discourage such matter from accumulating.

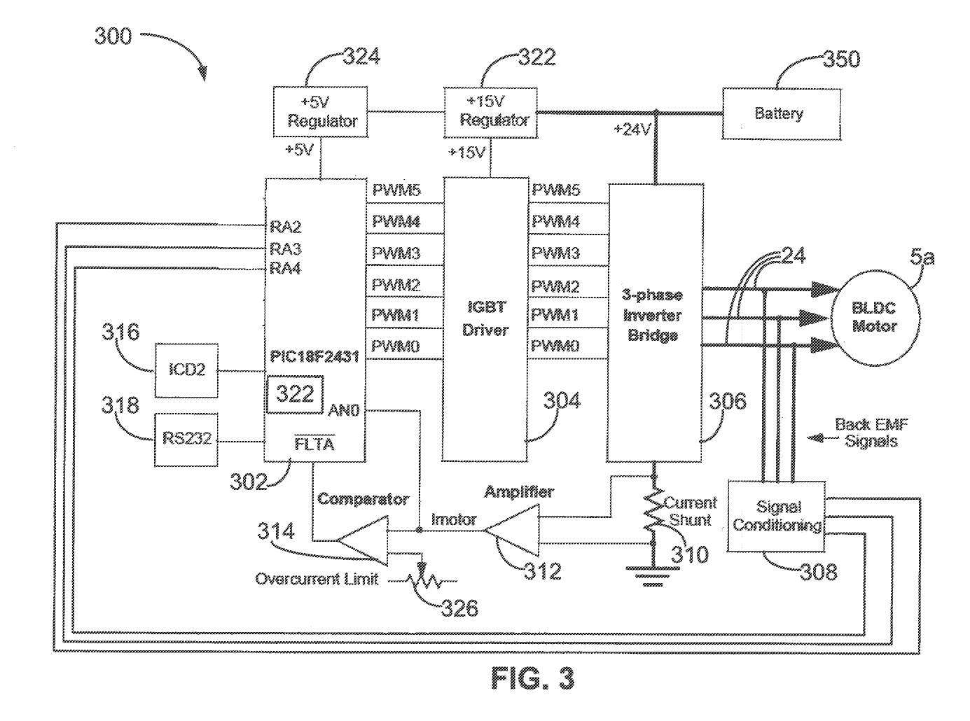

The motor assembly 5 is contained in a motor cavity 2; the motor assembly includes a brushless DC (“BLDC”) motor 5a (not shown in FIG. 1, but depicted in FIG. 3) and a rotary-to-linear motion converter such as a threaded ball-and-screw device as commonly used in the prior art (not shown) that converts the rotational output of the BLDC motor 5a into the reciprocating linear movement of the shaft 6. The shaft 6 is coupled to the motor assembly 5 through a sliding seal 7 in the wall of the motor cavity 2 so as to prevent the motor cavity 2 from being contaminated with the drilling mud. Instead, the motor cavity 2 contains clean fluid. A membrane 3 in the main housing 1 communicates with a port 4 in the motor cavity 2 wall so that the motor cavity 2 is pressure balanced with the annulus 20. In an alternative embodiment (not depicted), the membrane 3 can be replaced with a suitable bellows or a sliding piston. Motor control circuitry 300 (not shown in FIG. 1, but depicted in FIG. 3) is contained in a pressure shielded compartment (not shown) and drives the BLDC motor 5a to control operation of the pilot valve 8. The BLDC motor 5a may be driven to encode data for transmission to the surface via mud pulse telemetry, or to perform other functions, such as the performance of a cleaning cycle as will be described later.

Among the connections between the motor control circuitry 300 and the motor assembly 5 are feedthrough wires 24 that electrically couple the BLDC motor 5a to the motor control circuitry 300. Each of the feedthrough wires 24 are electrically coupled to one of the stator windings of the BLDC motor 5a to allow the motor control circuitry 300 to both power the BLDC motor 5a and to measure the back EMF signals generated by the BLDC motor 5a while it is operating, as discussed in further detail below. Measurement of the back EMF signals allows the motor control circuitry 300 to determine the position of the BLDC motor 5a 's rotor relative to its stator, which accordingly allows the motor control circuitry 300 to commutate the BLDC motor 5a, and to determine the degree to which the pilot valve 8 is opened or closed. The feedthrough wires 24 pass through a pressure barrier 26 that delineates the pressure shielded compartment. The feedthrough wires 24 are used to power the BLDC motor 5a during commutation and to transmit the back EMF signals generated during the BLDC motor 5a 's operation to the motor control circuitry 300. As used herein, “commutation” refers to sending electrical signals to the BLDC motor 5a such that the rotor of the BLDC motor 5a is torqued about its axis of rotation.

Sensorless control of the BLDC motor 5a in the manner described herein allows the same feedthrough wires 24 that power the BLDC motor 5a to be used to determine position, thus removing a need for separate additional wiring for motor sensors, and also eliminating the use of brushes, which increases motor reliability. As further explained below, use of sensorless control of the BLDC motor 5a further allows determination of pilot valve 8 position, useful for effective mud-pulse modulation, without needing to use of hall effect sensors.

Again with continued reference to FIG. 1, compression spring 11 acting on the piston 13 biases the piston 13 to move in the downwards direction towards the orifice 28. A port 16 maintains the pressure in the lower chamber 15 at the same pressure as exists inside annulus 20, and this pressure exerts an upwards force on the lower face 34 of the piston 13 against the compression spring 11.

The pressure in the upper chamber 12, providing the pilot valve 8 is closed, equalizes with the lower pressure below the orifice collar 18 via the control port 14 and hollow cylinder 30. The action of the spring 11 and the pressure in the upper chamber 12 are relatively weak and the piston 13 will rise due to the pressure in the lower chamber 15. The restriction at the orifice collar 18 is thus exposed and the pressure at the orifice reduces until an equilibrium is reached.

When the pilot valve 8 is opened however, mud flow enters the upper chamber 12 raising the pressure on the upper face 32 of the piston 13. The piston 13 moves downwards, moving the valve tip 22 towards the orifice collar 18 and, by restricting the flow of drilling mud through the orifice 28, increasing the pressure in the drill pipe 19 and annulus 20. The piston 13 continues to move downwards until the pressure in the upper chamber 12 combined with the spring force is balanced by the pressure acting on the piston 13's lower face 34, which is exposed to the fluid in the lower chamber 15. This feature provides a negative feedback and results in stable, proportional control. This downwards balanced position of the piston 13 corresponds to the mud pulser 10's on-pulse state in a binary signalling system.

When the pilot valve 8 is closed, the flow of mud into the upper chamber 12 is stopped. The pressure in the upper chamber 12 then equalizes with that at the valve tip 22. The pressure at the valve tip 22 is lower than the pressure in the narrower annulus 20, so that the pressure in the lower chamber 15 once again becomes higher than the pressure in the upper chamber 12. The piston 13 then gradually moves upwards against the action of the compression spring 11 until it adopts its initial or off-pulse position.

The position of the piston 13 when it has moved fully downwards to its on-pulse position will depend on the characteristics of the spring 11 and on the ratio of the hydraulic impedances of the control port 14, which allows mud flow between the upper chamber 12 and the hollow cylinder 22, and through the pilot valve 8, which allows mud flow between the pilot valve chamber 23 and the upper chamber 12.

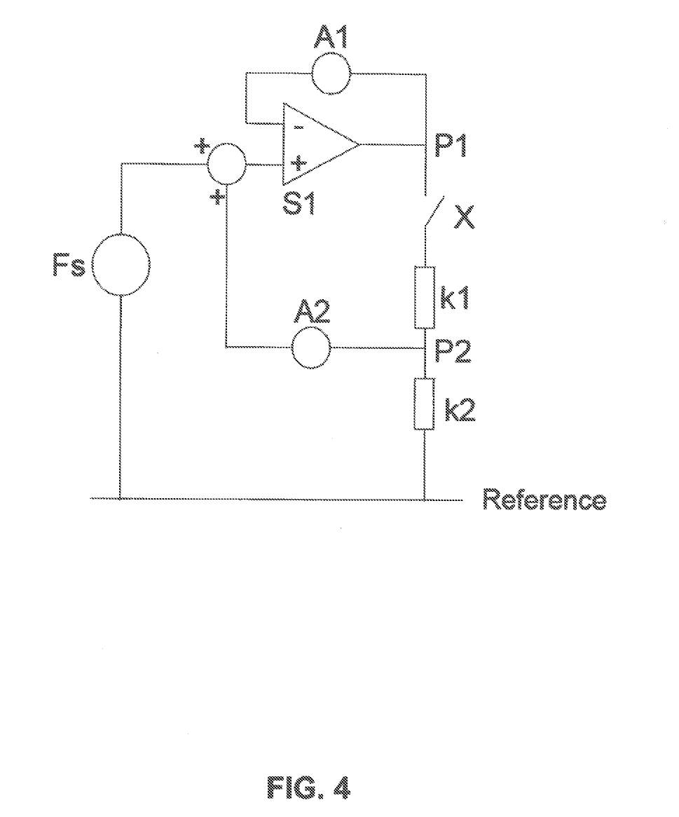

The amount of pressure modulation that can be achieved is dependent on the hydraulic impedances of the control port 14 and the pilot valve 8. If either of these becomes blocked, the piston 13 will not operate correctly and the telemetry provided by the device will fail. This is explained in more detail with reference to FIG. 4, below.

The operation of the mud pulser 10 is now analysed with certain simplifying assumptions.

It is assumed that the pressure inside the hollow cylinder 22 of the piston 13 is the same as the pressure below the orifice collar 18. This is true when the end of the hollow cylinder 22 is fully inserted into the orifice collar 18, and is nearly true when the end of the hollow cylinder 22 is fully retracted away from the orifice collar 18. The same assumption applies to the pressure on the thin annular surface on the end of the hollow cylinder 22 at the bottom of the piston 13.

The absolute pressure below the orifice collar 18 is taken as the reference from which other pressures are measured. In practice it is a constant pressure due to the hydraulic head and the relatively constant flow into the impedance represented by nozzles in the drill bit. Forces due to this reference pressure can then be ignored; alternatively this pressure can be treated as zero.

Referring now to FIG. 4, the orifice 30 and piston 13 are represented by a Servo S1, which creates the pressure P1 in the annulus 20 as the piston 13 moves due to any net input forces. Thus a net positive input force causes the piston to move downwards and thereby to increase pressure P1.

The force due to spring 11 is represented as Fs. Initially, it is convenient to assume that the spring 11 is precompressed and exerts a force which is nearly constant, irrespective of the position of the piston 13. A1 is the area of the lower face 34 of the piston 13, acted on by the pressure P1 in the lower chamber 15. A2 is the area of the upper face 32 of the piston 13, acted on by the pressure P2 in the upper chamber 12. The pilot valve 8 is represented as a switch X, and the pilot valve 8 (when open and drilling mud is flowing therethrough) is represented as hydraulic impedance k1. The control port 14 is represented as hydraulic impedance k2. When the pilot valve 8 is open, the switch X closes and fluid flows through both k1 and k2, and the pressure P2 in the upper chamber 12 depends on the ratio of the two impedances such that P2=P1·k2/(k1+k2). When the pilot valve 8 is closed, the switch X opens and the pressure P2 will drop to the reference level, treated here as zero. The forces acting on the piston 13, hence the inputs to the servo S1, are therefore Fs+P2−A2−P1·A1. Equilibrium is reached when this net force is zero.

Consider now two cases. In case 1, the pilot valve 8 is closed; consequently, the switch X is open, P2=0, and therefore P1=Fs/A1. In case 2, the pilot valve 8 is open; consequently, the switch X is closed, P2=P1·k2/(k1+k2), therefore Fs+P1·k2·A2/(k1+k2)−P1·A1=0 and P1=Fs/(A1−A2·k2/(k1+k2)). Note the restriction that A1>A2·k2/(k1+k2); otherwise the negative, self regulating feedback is not present, and the mud pulser 10 would not self-adjust in case 2. It is this negative feedback that compensates for variances in total mud flow rate, and that renders operation of the mud pulser 10 relatively independent of total flow rate. As a result, the main restrictor valve is able to properly function notwithstanding variable flowrates.

Now consider the result in case 2, and treat k1 as variable in response to the position of the shaft 6 relative to the valve seat/orifice 9. The system then becomes a proportional control system, allowing the position of the shaft 6 relative to the valve seat 9 of the linearly reciprocating pilot valve 8 to generate complex waveforms with amplitudes which are essentially independent of the mud flow rate.

It will be appreciated that a more thorough analysis would take account of the variable spring force, which would have the effect of raising pressure P1 slightly as higher flow rates demand that a different equilibrium position is found. Also, the pressure inside the hollow cylinder 30 of the piston 13 may not be always at the constant reference level, due to orifice flow and Bernoulli effects. They may be allowed for in a more detailed model, or be measured experimentally for a given design. However, the proportionality and self regulation effects may be seen to remain.

The foregoing illustrates that the ratio between the impedances k1 and k2 in one embodiment is maintained. Once the piston 13 has been put in place and the area values A1 and A2 fixed, the most likely way that the ratio of impedances will be affected will be due to the build up of LCM or other particulate matter in one or more of the control or valve ports. The linearly reciprocating shaft 6 can beneficially be overdriven into the valve seat 9 such that any LCM that is obstructing the pilot valve 8 can be crushed or forced through the pilot valve 8, thereby helping to maintain constant the ratio of k1 and k2.

Since the mud pulser 10 produces a pressure increase in the drill pipe 19 that is proportional to the impedances of the ports, it is possible to control the pilot valve 8 to produce complex modulation as well as simple binary pulses. Amplitude modulation for example can be achieved by partially opening the pilot valve such that it is opened a fraction of its completely opened state so that a smaller pressure pulse is created.

A variety of modulation schemes are possible; for example, the mud pulser 10 may use amplitude, phase or frequency, or combinations of all three therefore in order to increase the data rate. Furthermore, although the pilot valve 8 in the foregoing embodiment is a linearly reciprocating valve (ie a “poppet and orifice” type valve), in alternative embodiments different types of pilot valves may be used. For example, the pilot valve 8 may be rotary valve.

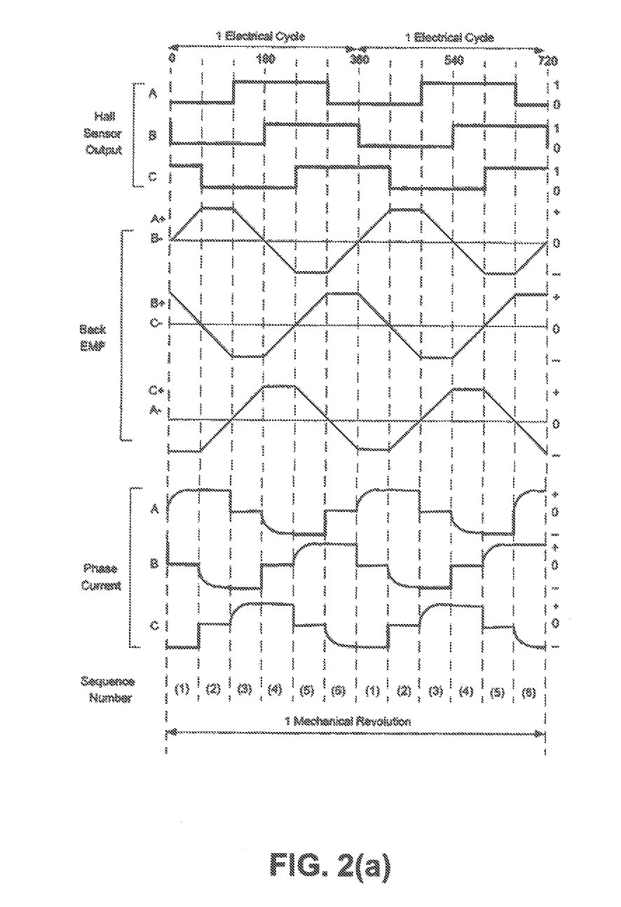

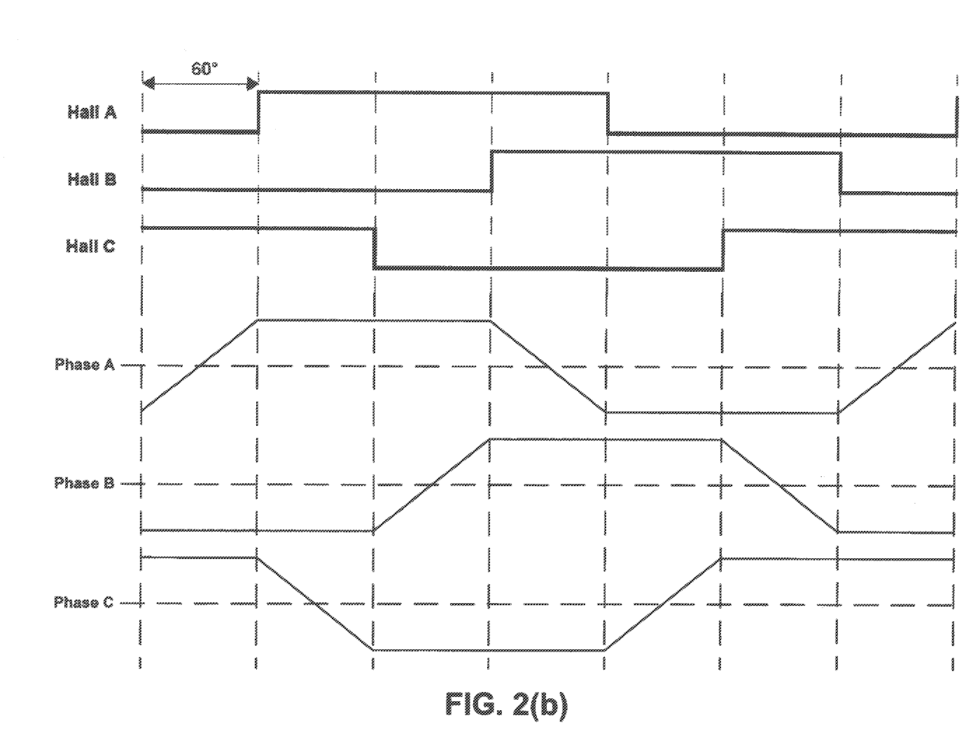

As discussed above, the back EMF signals generated by the BLDC motor 5a during its operation are used to commutate the BLDC motor 5a. Referring now to FIG. 2(a), there are shown graphs of various signals as measured over one full (360°) revolution of the output shaft of multipole BLDC motor 5a installed in the mud pulser 10: the back EMF signals generated during the BLDC motor 5a's operation and the phase current supplied to the BLDC motor 5a from the motor control circuitry 300 during motor commutation. Also shown, for reference, are the signals that would be generated by Hall Effect sensors that are conventionally used to monitor rotor position and for commutation. The BLDC motor 5a whose characteristics are depicted in FIG. 2(a) has two pairs of poles on its rotor; consequently, every 30° of mechanical rotation corresponds to 60° of an electrical cycle.

The BLDC motor 5a in the present exemplary embodiment has three stator windings: A, B, and C. As shown in FIG. 2(a), the three stator windings are electrically coupled such that the back EMF signals that are generated are trapezoidal. In alternative embodiments (not depicted), the BLDC motor 5a may have more than three stator windings, and they may be electrically coupled to generate back EMF signals of different waveforms (e.g.: sinusoidal).

The graph of Hall Effect sensor output in FIG. 2(a) shows what the output would be of three Hall Effect sensors mounted in the BLDC motor 5a; one sensor is mounted adjacent to each of the stator windings. Every 30° of mechanical rotation, which as mentioned above corresponds to 60° of an electrical cycle, the output of one of the Hall Effect sensors changes from high to low or vice-versa. Every 180° of mechanical rotation the outputs of the Hall Effect sensors repeat; as the Hall Effect sensor outputs change every 30° of mechanical rotation, the BLDC motor 5a can be commutated by recognizing six different electrical sequences that are used during commutation: 1 through 6, as noted in FIG. 2(a). Table 1 shows the voltage that the motor control circuitry 300 applies across the stator windings of the BLDC motor 5a during each of these six sequences for clockwise rotation:

TABLE 1
Voltage Applied Across Stator Windings for Clockwise BLDC Motor 5a
Rotation

| | Voltage Across | Voltage Across | Voltage Across |
|---|---|---|---|
| Sequence | Stator Winding A | Stator Winding B | Stator Winding C |
| 1 | +DC | 0 | −DC |
| 2 | +DC | −DC | 0 |
| 3 | 0 | −DC | +DC |
| 4 | −DC | 0 | +DC |
| 5 | −DC | +DC | 0 |
| 6 | 0 | +DC | −DC |

Table 2 shows the voltage that the motor control circuitry 300 applies across the stator windings of the BLDC motor 5a during each of these six sequences for counter-clockwise rotation:

TABLE 2
Voltage Applied Across Stator Windings for Counter-clockwise BLDC
Motor 5a Rotation

| | Voltage Across | Voltage Across | Voltage Across |
|---|---|---|---|
| Sequence | Stator Winding A | Stator Winding B | Stator Winding C |
| 1 | 0 | −DC | +DC |
| 2 | +DC | −DC | 0 |
| 3 | +DC | 0 | −DC |
| 4 | 0 | +DC | −DC |
| 5 | −DC | +DC | 0 |
| 6 | −DC | 0 | +DC |

The current that passes through the stator windings when the motor is commutated in accordance with Table 1 is depicted in the “Phase Current” graphs of FIG. 2(a).

When commutating a conventional BLDC motor using readings from Hall Effect sensors as feedback, the motor control circuitry 300 detects the current electrical sequence for the motor based on the readings of the Hall Effect sensors, and governs (commutates) the motor by applying the voltages across the different phase windings of the motor as shown in Tables 1 or 2, depending on whether clockwise or counter-clockwise rotation is desired.

In the exemplary embodiments discussed herein, however, the BLDC motor 5a is not equipped with sensors. Instead of using sensor feedback to determine when to commutate the motor, the motor circuitry relies on the back EMF signals that the BLDC motor 5a generates during operation. In FIG. 2(a), the back EMF signal on the graph labelled ““A+/B−” is measured across winding A; the back EMF signal on the graph labelled “B+/C−” is measured across winding B; and the back EMF signal on the graph labelled “C+/A−” is measured across winding C.

As shown in the graph of “back EMF” signals, each of the Hall Effect sensor transitions corresponds to a phase transition in one of the back EMF signals; this phase transition is also known as a “zero crossing”. By monitoring these back EMF signal phase transitions, the motor control circuitry 300 is able to commutate the BLDC motor 5a without relying on readings from the Hall Effect sensors. In alternative embodiments (not discussed), the motor control circuitry 300 may commutate the BLDC motor 5a based on more or different information than phase transitions. For example, the motor circuitry 300 may record the entirety of the back EMF signals, determine the maximum and minimum values of the back EMF signals and when they occur, and from this information determine when to commutate the BLDC motor 5a.

As mentioned above, the exemplary BLDC motor whose characteristics are depicted in FIG. 2(a) has two pairs of poles on its rotor. In alternative embodiments, BLDC motors having more or fewer pairs of poles on its rotor can be used and the graphs shown in FIG. 2(a) will accordingly change. For example, the graphs of FIG. 2(b) depict characteristics of an exemplary BLDC motor that has a single pair of poles on its rotor. As in FIG. 2(a), the output of Hall Effect sensors are contrasted with the back EMF signals measured across stator windings A, B and C. In contrast to the motor of FIG. 2(a), 60° of mechanical rotation corresponds to 60° of an electrical cycle. Additionally, in the motor of FIG. 2(b) the phase transitions/zero crossings in the back EMF signals are offset 30° from the corresponding edges in the signals from the Hall Effect sensors. The motor control circuitry 300 can be configured to compensate for this 30° offset, and for any similar offset that may exist in BLDC motors of alternative embodiments, such that the back EMF signals can still be used to efficiently and properly commutate the BLDC motor. In further alternative embodiments (not depicted), BLDC motors having any suitable number of stator or rotor poles can be used.

Referring now to FIG. 3, there is shown a block diagram of the motor control circuitry 300. The motor control circuitry 300 includes a microcontroller 302 which, in the depicted embodiment, is a Microchip™ PIC18F2431 microcontroller manufactured by Microchip Technology Inc. of Chandler, Ariz., USA. In alternative embodiments (not depicted), any suitable controller, such as a processor, microcontroller, programmable logic controller, field programmable gate array, can be used, or the functionality of the microcontroller 302 may be implemented using, for example, an application-specific integrated circuit. The microcontroller 302 includes a computer readable medium 322, such as flash memory, that stores instructions regarding how to commutate the motor. The microcontroller 302 controls commutation of the BLDC motor 5a by using pulse width modulation on outputs PWM[0 . . . 5], which are amplified using an IGBT driver 304. For clockwise motor rotation, the active PWM[0 . . . 5] outputs for the six electrical sequences are as follows:

TABLE 3
Active PWM[0 . . . 5] Outputs of the Microcontroller 302 for Clockwise
BLDC Motor Rotation

| Sequence | Active PWM[0 . . . 5] Outputs |
|---|---|
| 1 | PWM1, PWM4 |
| 2 | PWM1, PWM2 |
| 3 | PWM5, PWM2 |
| 4 | PWM5, PWM0 |
| 5 | PWM3, PWM0 |
| 6 | PWM3, PWM4 |

For counter-clockwise motor rotation, the active PWM[0 . . . 5] outputs for the six electrical sequences are as follows:

TABLE 4
Active PWM[0 . . . 5] Outputs of the Microcontroller 302 for Counter-
clockwise BLDC Motor Rotation

| Sequence | Active PWM[0 . . . 5] Outputs |
|---|---|
| 1 | PWM5, PWM2 |
| 2 | PWM1, PWM2 |
| 3 | PWM1, PWM4 |
| 4 | PWM3, PWM4 |
| 5 | PWM3, PWM0 |
| 6 | PWM5, PWM0 |

The IGBT driver 304 outputs the amplified PWM[0 . . . 5] outputs to a 3-phase inverter bridge 306 that applies the proper voltages across the three stator windings of the BLDC motor 5a via the feedthrough wires 24, in accordance with Tables 1 and 2.

A battery 350 supplies 24V DC power for use by the 3-phase inverter bridge 306, a 15V voltage regulator 322 that powers the IGBT driver 304, and another 15V voltage regulator 324 that powers the microcontroller 302. The microcontroller 302 also has RS232 and ICD2 inputs, which are coupled to RS232 circuitry 318 and ICD2 circuitry 316 and used for serial communication (e.g.: programming the microcontroller 302) and debugging, respectively.

A current shunt 310 is electrically coupled to the 3-phase inverter bridge 306. The current shunt 310 detects the amount of current being drawn from the DC power supply. A signal indicative of the drawn current (“drawn current signal”) is amplified by an amplifier 312 and fed to a comparator 314. The comparator 314 compares the drawn current signal against a signal across an overcurrent resistor 326 that represents the current limit for the motor control circuitry 300. When the drawn current signal exceeds the current limit, the output of the comparator 314 goes low and triggers the active low fault detection FLTA_bar of the microcontroller 302. The microcontroller 302 can thereby detect a fault or that the shaft 6 has reached an end position. For example, when the shaft 6 is overdriven into the closed position in order to crush or force any LCM through the valve seat/orifice 9 (a “cleaning cycle”), after the pilot valve 8 completely closes any further overdriving of the shaft 6 into the valve seat/orifice 9 will increase the current that the BLDC motor 5a draws from the motor control circuitry. Following detection of this increase in current, the microcontroller 302 can start a timer or count a certain number of sequences prior to ceasing driving lines 24 and motor 5a.

Signal conditioning circuitry 308 is electrically coupled to the feedthrough wires 24 and is used to measure and condition the back EMF signals before sending output signals to the IC[1 . . . 3] inputs of the microcontroller 302. In the depicted embodiment the signal conditioning circuitry 308 includes a voltage divider to reduce the measured back EMF signals to those within the input range of the microcontroller 302, and also low pass filters to mitigate noise related to high frequency signal components that result from the edge transitions shown in FIG. 2(a). A variety of methods can be used to measure the back EMF signals; these methods include comparing the voltage of each of the feedthrough wires 24 to half the DC voltage (12.5V in the depicted embodiment) used to drive the BLDC motor 5a; comparing the voltage of each of the feedthrough wires 24 to a virtual ground signal; and simply sampling the voltage of each of the feedthrough wires 24 and inputting that value directly into the microcontroller 302 for digitization and use. In the first two methods, the result of the comparison is a square wave in which the wave is high when the back EMF voltage is greater than zero and low when the back EMF voltage is less than zero; consequently, the microcontroller 302 can rely on edge detection to determine where the phase transitions of the back EMF signals occur. In the third method, a digitized version of the entire trapezoidal back EMF signal is input to the microcontroller 302. To determine when the phase transitions occur, the microcontroller 302 compares the digitized back EMF signal to a reference zero point. As mentioned above, in alternative embodiments (not depicted) the microcontroller 302 may consider more or different information than zero crossings. For example, the microcontroller 302 may additionally or alternatively utilize the entire waveform of the back EMF signals to determine any one or more of their rate of change; maximum and minimum values; and overall shape in order to determine how and when to commutate the BLDC motor 5a.

In FIG. 3, the BLDC motor 5a is contained in the motor cavity 2, which is exposed to relatively high downhole pressures. However, the motor control circuitry 300 itself is contained within the pressure shielded cavity, and only the feedthrough wires 24 cross the pressure barrier 26 that delineates the pressure shielded cavity and enter the motor cavity 2. As discussed above, this helps to reduce the costs associated with constructing and operating the mud pulser 10.

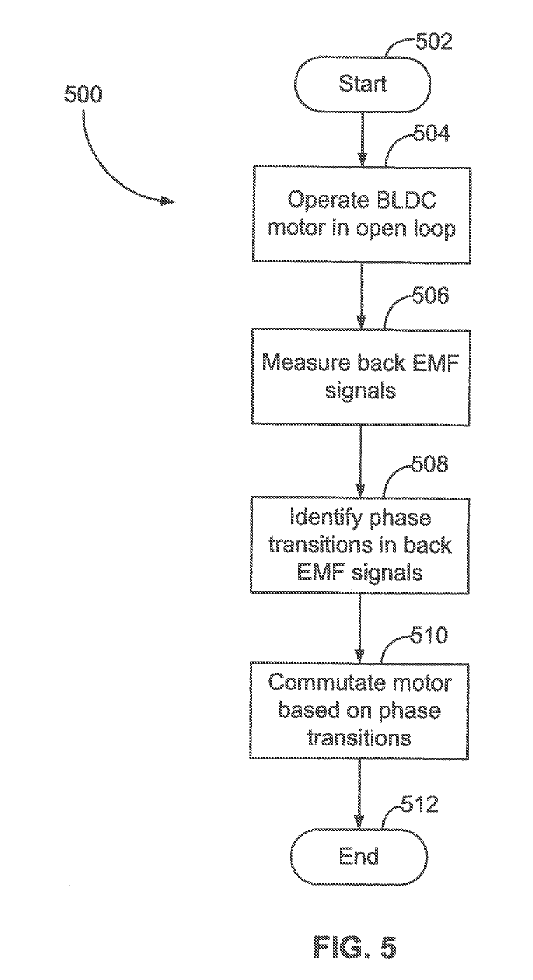

Referring now to FIG. 5, there is shown a method 500 for operating the mud pulser 10, according to another embodiment. The method may be stored in the computer readable medium 322 of the microcontroller 302, or on any other suitable computer readable medium, including disc-based media such as CD-ROMs and DVDs, magnetic media such as hard drives and other forms of magnetic disk storage, semiconductor based media such as flash media, random access memory, and read only memory. When performing the method 500, the microcontroller 302 first begins at block 502 and proceeds immediately to block 504. At block 504, the microcontroller 302 commutates the BLDC motor 5a in open loop; i.e., without the benefit of any feedback from the back EMF signals. Open loop commutation is first performed because back EMF signals result from rotation of the rotor through the magnetic field generated by the stator, and are initially lacking

Once the BLDC motor 5a is operating and is generating the back EMF signals, the motor control circuitry 300 is able to measure the back EMF signals at block 506 and identify the phase transitions that occur in the back EMF signals at block 508. Once the phase transitions are identified, the microcontroller 302 is able to commutate the BLDC motor 5a based on the phase transitions at block 510. As discussed above, the microcontroller 302 is able to cause the BLDC motor 5a to rotate in clockwise or counter-clockwise directions; in the present embodiment, this corresponds to moving the shaft 6 of the pilot valve 8 towards the valve seat/orifice 9 and moving the shaft 6 of the pilot valve 8 away from the valve seat/orifice 9, respectively. In a binary signalling scheme, a high pressure or “1” signal can be sent by completely opening the pilot valve 8; e.g. by rotating the BLDC motor 5a counter-clockwise to cause the shaft 6 to retract from the valve seat/orifice 9 such that the shaft 6 does not impede mud flow through the pilot valve 8. Similarly, a low pressure or “0” signal can be sent by closing the pilot valve 8; e.g. by rotating the BLDC motor 5a clockwise to cause the tip of the shaft 6 to block the valve seat/orifice 9, which prevents mud from flowing through the pilot valve 8.

Through calibration prior to downhole deployment, the microcontroller 302 can be programmed with the total number of motor rotations (including fractional portions or increments thereof) used to transition the pilot valve 8 from the completely closed position (i.e. when the shaft 6 is inserted as far as possible into the valve seat 9) to the completely opened position (i.e. when the shaft 6 is retracted as far as possible from the valve seat 9). By keeping a count of the number of motor rotations (including fractional portions or increments thereof) the BLDC motor 5a has undergone relative to either the completely opened or the completely closed positions, the microcontroller 302 is able to determine where between the completely opened and completely closed positions the tip of the shaft 6 is, and is consequently able to vary the flow rate of the mud through the pilot valve 8. In this way, the microcontroller 302 can control the height of the pressure pulses that the mud pulser 10 transmits, and send messages encoded using non-binary modulation schemes, such as quadrature amplitude modulation.

For example, the microcontroller 302 may wish to move the shaft 6 halfway between the completely opened and completely closed positions. This may generate a pressure pulse having a pulse height of 0.5 relative to the pressure pulse generated when the pilot valve 8 is completely opened. From calibration at the time of manufacture, the microcontroller 302 may be programmed with the knowledge that moving the distance between the completely opened and completely closed positions takes twenty mechanical revolutions, which corresponds to forty electrical cycles and a certain number of back EMF phase transitions, or two hundred and forty sequences of 1 through 6. Thus a certain number of back EMF phase transitions can accordingly be converted into changes in position of the pilot valve 8.

To move half the distance between completely opened and closed, the microcontroller first moves the pilot valve 8 to the completely closed position by overdriving the shaft 6 into the valve seat/orifice 9; this may be done either by rotating twenty mechanical revolutions clockwise regardless of the current position of the pilot valve 8 or by driving a certain number of revolutions after detection of an increase in drawn current via the FLTA_bar input. The maximum current can be appropriately limited such that the shaft 6 is not damaged while being overdriven. Beneficially, this re-references the pilot valve 8 to the completely closed position, and if the BLDC motor 5a has sufficient torque output the shaft 6 will also crush any LCM that may be blocking the pilot valve 8. After being re-referenced to the completely closed position, the microcontroller 302 rotates the BLDC motor 5a counter-clockwise 10 mechanical revolutions, and monitors the back EMF signals to track how far the shaft 6 has travelled. As discussed above, the number of zero crossings that have occurred in the back EMF signals corresponds to a certain number of mechanical revolutions of the BLDC motor 5a, which in turn corresponds to the distance the shaft 6 has moved; the microcontroller 302 is accordingly able to monitor where the shaft 6 is and the degree to which the pilot valve 8 is opened or closed by counting the number of phase transitions in the back EMF signals. As discussed above, in an alternative embodiment (not discussed), more information from the back EMF signals than the phase transitions can be used to determine the position of the shaft 6.

After the ten mechanical revolutions, the microcontroller 302 can either re-reference the shaft 6 to either the completely opened or closed positions, or simply commutate the BLDC motor 5a such that the tip of the shaft 6 is moved to another desired position between completely opened and completely closed by counting back EMF phase transitions using the halfway position as a starting point. By counting revolutions through monitoring the back EMF signals in this way, the mud pulser 10 is able to move the pilot valve 8 different distances and to different desired positions, and to transmit mud pulses of various heights. Following commutation, the method ends at block 512. In the foregoing example, the microcontroller 302 uses the completely closed position as a reference for the pilot valve 8 prior to counting mechanical revolutions; in an alternative embodiment (not shown), the microcontroller 302 may use the completely opened position as the reference.

In an exemplary embodiment, a feedback system is provided in the mud pulser, which operates in conjunction with the main restrictor valve thereof to prevent operator-induced flow changes in mud flow rates from interfering with and/or denigrating the mud pulse telemetry signals generated by the mud pulser. Again, with a view to eliminating or reducing the effect of variations in mud flow pressure due to variations in mud flow caused by drilling operator at surface, which would otherwise denigrate the quality of the mud pulses or impair the efficiency and manner of mud pulser operation, the method may further comprise providing feedback to or from the main restrictor valve to compensate for such variances in mud flow.

In an exemplary embodiment, a feedback system is provided in the mud pulser, which operates in conjunction with the main restrictor valve thereof to prevent operator-induced flow changes in mud flow rates from interfering with and/or denigrating the mud pulse telemetry signals generated by the mud pulser. Again, with a view to eliminating or reducing the effect of variations in mud flow pressure due to variations in mud flow caused by drilling operator at surface, which would otherwise denigrate the quality of the mud pulses or impair the efficiency and manner of mud pulser operation, the method may further comprise providing feedback to or from the main restrictor valve to compensate for such variances in mud flow.

The mud pulser of the present design (and the within method of controlling a mud pulser) avoids the necessity of using position sensors to sense the position of the shaft, yet despite the lack of sensors is nonetheless able to provide efficient commutation of the motor windings to operate the motor, and with the further ability to accurately determine position of the pilot valve which is needed in order to provide accurate and full mud pulse modulation.

The use of such a system avoids expensive sensors, yet permits modulation of complex pressure waveforms (in addition to simple on/off modulation), thereby allowing data to be transmitted in substantial quantities over a set interval of time, thereby keeping power utilized from the battery to a minimum and thereby preserving battery life used to power the DC motor, thereby reducing the number of times the mud pulser may need to be replaced.

For the sake of convenience, the exemplary embodiments above are described as various interconnected functional blocks or distinct software modules. This is not necessary, however, and there may be cases where these functional blocks or modules are equivalently aggregated into a single logic device, program or operation with unclear boundaries. In any event, the functional blocks and software modules or features of the flexible interface can be implemented by themselves, or in combination with other operations in either hardware or software.

Moreover, no element of any of the claims appended to this application is to be construed under the provisions of 35 USC §112, sixth paragraph, as being limited to only the specific mechanical configuration disclosed in the specification, unless the claim element is expressly recited using the exact phrase “means for” or “step for”.

While particular example embodiments have been described in the foregoing, it is to be understood that other embodiments are possible and are intended to be included herein. It will be clear to any person skilled in the art that modifications of and adjustments to the foregoing example embodiments, not shown, are possible.

What is claimed is:

1. A method for controlling a measurement-while-drilling mud pulser, the method comprising:
operating a brushless DC motor that controls a main restrictor valve in the mud pulser used to generate mud pulses;
measuring back EMF signals generated in the stator windings of the brushless DC motor during motor operation; and
governing the rotation of the brushless DC motor based on the back EMF signals.

2. The method of claim 1 further comprising identifying phase transitions in the back EMF signals, and governing rotation of the brushless DC motor based on the identified phase transitions in the back EMF signals.

3. The method of claim 1 wherein the brushless DC motor controls a pilot valve hydraulically coupled to the main restrictor valve.

4. The method of claim 3 further comprising providing feedback to the main restrictor valve to compensate for variances in mud flow rate.

5. The method of claim 1 further comprising keeping a count of phase transitions in a given motor direction as a means of determining position of a pilot valve .

6. The method of claim 5, wherein keeping a count of phase transitions in a given motor direction as a means of determining position of a pilot valve is made relative to a completely opened position or completely closed position of the pilot valve.

7. The method of claim 3 wherein the pilot valve is a “poppet and orifice” type valve that linearly reciprocates in response to operation of the brushless DC motor.

8. The method of claim 3 wherein the pilot valve is a rotary valve that rotates in response to operation of the brushless DC motor.

9. The method of claim 6 wherein the pilot valve is movable between completely opened and completely closed positions, the method further comprising moving the pilot valve to a desired position between the completely opened and completely closed positions by:
moving the pilot valve to either the completely opened position or completely closed position; and
thereafter operating the brushless DC motor over a number of phase transitions so as to cause movement of the pilot valve to a desired position up to or between the completely open and the completely closed position.

10. The method of claim 5 further comprising moving the pilot valve to the completely closed position by overdriving the pilot valve into the completely closed position.

11. The method of claim 9 further comprising tracking the position of the pilot valve by counting a number of phase transitions relative to the completely closed position or the completely opened position, and by converting the number of phase transitions to changes in position of the pilot valve.

12. A measurement-while-drilling mud pulser, the mud pulser comprising:
a housing;
a pilot valve contained within the housing and movable between completely opened and completely closed positions;
a main restrictor valve hydraulically coupled to the pilot valve and movable between opened and closed positions in response to movement of the pilot valve;
a motor assembly comprising a brushless DC motor, the brushless DC motor mechanically coupled to the pilot valve to move the pilot valve between the completely opened and completely closed positions;
motor control circuitry electrically coupled to the motor assembly, wherein the motor control circuitry is configured to:
operate the brushless DC motor;
measure back EMF signals generated in the stator windings of the brushless DC motor during motor operation; and
govern rotation of the brushless DC motor based on the back EMF signals.

13. The mud pulser of claim 12 wherein the motor control circuitry is further configured to:
identify phase transitions in the back EMF signals; and
commutate the brushless DC motor based on the phase transitions in the back EMF signals.

14. The mud pulser of claim 12 wherein the pilot valve is a “poppet and orifice” type valve, and wherein the motor assembly further comprises a rotary-to-linear converter mechanically coupled between the brushless DC motor and the “poppet and orifice” type valve to enable linear reciprocation of the “poppet and orifice” type valve.

15. The mud pulser of claim 12 wherein the pilot valve is a rotary valve that rotates in response to operation of the brushless DC motor.

16. The mud pulser of claim 12 wherein the motor control circuitry is further configured to keep a count of phase transitions in a given motor direction as a means of determining position of the pilot valve relative to the completely opened position or completely closed position.

17. The mud pulser of claim 12 wherein the motor control circuitry is further configured to position the pilot valve to a desired position between the completely opened and completely closed positions by:
operating the brushless DC motor so as to correspondingly move the pilot valve to a reference position that is the completely closed position or the completely opened position; and
operating the brushless DC motor a number of phase transitions so as to move the pilot valve to the desired position from the reference position.

18. The mud pulser of claim 12 wherein the motor control circuitry is further configured to move the pilot valve to the completely closed position by overdriving the pilot valve into the completely closed position.

19. The mud pulser of claim 12 wherein the motor control circuitry is further configured to track the position of the pilot valve by counting a number of phase transitions relative to the completely closed position or the completely opened position, and converting the number of phase transitions to changes in position of the pilot valve.

20. A computer readable medium having encoded thereon statements and instructions to cause a controller to perform a method as claimed in claim 1.

21. A measurement-while-drilling mud pulser, comprising:
a housing;
a pilot valve contained within the housing and movable between completely opened and completely closed positions;
a main restrictor valve hydraulically coupled to the pilot valve and movable between opened and closed positions in response to movement of the pilot valve;
a motor cavity contained within the housing;
a motor assembly contained within the motor cavity and comprising a brushless DC motor, the brushless DC motor mechanically coupled to the pilot valve to move the pilot valve between the completely opened and completely closed positions;
motor control circuitry electrically coupled to the motor assembly, the motor control circuitry further comprising:
means for energizing stator windings of the brushless DC motor;
means for measuring back EMF signals generated by the stator windings of the brushless DC motor during motor operation; and
means for individually energizing, when desired, the individual stator windings, based on the back EMF signals.
